(19) United States
(12) Patent Application Publication
(10) Pub. No.: US 2025/0088549 A1
(43) Pub. Date: Mar. 13, 2025

(54) One On One

(71) Applicant: One-On-One Solutions LLC, Washington, DC (US)

(72) Inventor: Rufat Aghayev, Washington DC, DC (US)

(21) Appl. No.: 18/367,074

(22) Filed: Sep. 12, 2023

(51) Int. Cl. H04L 65/403; G06F 3/0488; G06Q 50/00

(52) U.S. Cl. CPC H04L 65/403; G06F 3/0488; G06Q 50/01

(57) ABSTRACT

A match-making system, method and app provides users an environment to interact with each other on an exclusive basis so that only two users communicate. Users' profiles with their pictures are shown to each other based on their gender, radius and other preferences. Once both users indicate they are matched, the search stops. Both users' profiles become invisible to others on the app. There are no other matches in their inboxes. The whole focus is on the conversation between these two users from the moment they match.

### BACKGROUND

### Technical Field

This disclosure relates to a system for matching parties using a dating application. In particular, but without limitation, the disclosure relates to a match-making system using a selection method that puts interested parties in contact with each other based on certain preferences only with one user and another until they decide to meet.

The current stage of the online dating apps is that people can match and talk with more than one person simultaneously. This approach reduces the probability of creating meaningful connections since having too many options makes focusing on one person challenging. Having multiple matches in their inbox negatively impacts the quality of the conversations. People continue swiping while talking with existing matches, hence losing interest or forgetting about them as they match with new profiles. Due to the large number of matches in their inbox users have hard time keeping in touch or keep conversations going. As a result, users spend a lot of time messaging with multiple users without getting any results in this case meeting or getting to know each other closely thus missing out on the opportunity to have a meaningful connection.

Therefore, a need exists for a system that can conveniently match up interested parties with a simple interface and selection criteria for an exclusive session so the application exchange between the two parties is just for the two parties until they decide to meet or end conversation.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

A match-making system, method and app provides users an environment to interact with each other on an exclusive basis so that only two users communicate with each other. Users' profiles with their pictures are shown to each other based on their gender, radius and other preferences. Once both users indicate they are matched, the search stops. Both users' profiles become invisible to others on the app. There are no other matches in their inboxes. The whole focus is on the conversation between these two users.

In an aspect of the disclosure, computer-implemented method for matching interested parties in a dating environment using a match-making application is disclosed. The method includes providing a user interface for a user to enter profile information into the match-making application; presenting one or more potential matches to a user from the match-making application based on a user's demographic information preferences, locational preferences and/or pre-determined match criteria; allowing the user to select a desired match from the one or more potential matches; and upon selecting the desired match by the user: connecting the user with the desired match within the match-making application to an exclusion of connecting with other potential matches in the match-making application, where a user profile card and a desired match profile card are hidden from other potential matches and a search for other potential matches is stopped for both the user and the desired match; during the exclusive session where the user and the desired match communicate with each other exclusively on the match-making application until the user and/or the desired match initiate a selection action.

In an aspect, an apparatus supporting a matching interested parties in a dating environment is disclosed. The apparatus includes at least one processor; and at least one memory including computer program code for one or more programs, the at least one memory and the computer program code configured to, with the at least one processor, cause the apparatus to perform at least the following: The method includes providing a user interface for a user to enter profile information into the match-making application; presenting one or more potential matches to a user from the match-making application based on a user's demographic information preferences, locational preferences and/or pre-determined match criteria; allowing the user to select a desired match from the one or more potential matches; and upon selecting the desired match by the user: connecting the user with the desired match within the match-making application to an exclusion of connecting with other potential matches in the match-making application, where a user profile card and a desired match profile card are hidden from other potential matches and a search for other potential matches is stopped for both the user and the desired match; the user and the potential match communicate exclusively with each other.

In an aspect, a non-transitory computer-readable storage medium is disclosed, carrying one or more sequences of one or more instructions which, when executed by one or more processors, cause an apparatus to perform: The method includes providing a user interface for a user to enter profile information into the match-making application; presenting one or more potential matches to a user from the match-making application based on a user's demographic information preferences, locational preferences and/or pre-determined match criteria; allowing the user to select a desired match from the one or more potential matches; and upon selecting the desired match by the user: connecting the user with the desired match within the match-making application to an exclusion of connecting with other potential matches in the match-making application, where a user profile card and a desired match profile card are hidden from other potential matches and a search for other potential matches is stopped for both the user and the desired match; the user and the potential match communicate exclusively with each other.

Other systems, methods, features and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like referenced numerals designate corresponding parts throughout the different views.

FIG. 1 is an example process flow for acts taken in a for matching interested parties in a dating environment using a match-making application, according to an aspect of the disclosure.

FIG. 2 is an example communications network to support the disclosure.

### DETAILED DESCRIPTION

The elements in the Figures interoperate as explained in more detail below. Before setting forth the detail explanation, however, it is noted that all of the discussion below, regardless of the particular implementation being described, is exemplary in nature, rather than limiting. For example, although selected aspects, features, or components of the implementations are depicted as being stored in memories, all or part of systems and methods consistent with the display systems may be stored on, distributed across, or read from other machine-readable media, for example, secondary storage devices such as hard disks, floppy disks, and CD-ROMs; a signal received from a network; or other forms of ROM or RAM either currently known or later developed.

Furthermore, although specific components of the architecture will be described, methods, systems, and articles of manufacture consistent with the architecture may include additional or different components. For example, a processor may be implemented as a microprocessor, microcontroller, application specific integrated circuit (ASIC), discrete logic, or a combination of other type of circuits or logic. Similarly, memories, may be DRAM, SRAM, Flash, or any other type of memory. Flags, data, databases, tables, and other data structures may be separately stored and managed, may be incorporated into a single memory or database, may be distributed, or may be logically and physically organized in many different ways. Programs may be parts of a single program, separate programs, or distributed across several memories and processors.

In the disclosed match-making system and method, users' profiles with their pictures are shown to each other based on their gender, radius of location (with varying of levels of distance depending on subscription level) and other preferences (such as interests, hobbies, profession, education or other preferences provided by the application). Once both users indicate interest (such, for example, a “swipe right”), they are matched and the search for the users stops. Both users' profiles become invisible to others on the app—there are no other matches in their inboxes. Just one. The whole focus is on the conversation between these two users, to the exclusion of and avoiding distractions from others.

This feature improves the following:

1) This feature increases the probability of finding meaningful connection significantly faster since the users who sign up for this app are willing to invest in getting to know someone without having alternatives parallelly.

2) This feature increases the quality of the conversations making them special since they are built based on only 2 users who take their time to get to know each other versus conversations with multiple users on a surface level.

3) This feature eliminates time waste since the conversations are between only 2 users and users have the chance to get the most out of conversations versus having multiple incomplete/unfinished conversations that get lost/forgotten due to continuously growing inbox.

4) Rather than having users' pictures visible to other users on the app while they are already matched with one, their pictures will not be visible to others while interacting with their match for a period of time while matched. This will protect users' reputation and privacy.

5) This feature will eliminate the issue of matching and ghosting/not engaging with users. Rather than allowing “over-swiping right” (e.g., selecting a desired match without an intention to match, such as out of curiosity, validation, retaining many options to match later or just boredom), users will be swiping right/selecting desired matches more carefully because they are aware that this user is going to be the only user they will be interacting with for a period of time. Users will be less likely to abuse the match options in the app.

They are not allowed to exchange phone numbers or social media accounts until they meet in person. This also creates a safe space for people to interact.

This feature improves the following:

1) Rather than exchanging phone numbers and making the conversation unnecessarily personal, having pressure or obligation, especially the uncomfortable occasions when people match, exchange numbers, and the moment they lose interest they have to choose between texting the person to reject or “ghost”, with the disclosed match-making system and method, users will not have to think about it or feel obligated because asking for contacts or social media account is not allowed.

2) Additionally, there's no need to take the conversation offline since there's no one else on the app except these two users.

The disclosed match-making system and method operates as follows. As both users get to know each other, if both users secretly click on an indicator icon such as an “I think it's a match” button or icon on a touchscreen display.

The disclosed match-making system and method disconnects these two users if any of the users select an “un-match option” such as clicking or selecting a button, icon or menu item such as an “I don't think it's a match(unmatch)” selection.

This feature improves the following:

1) Rather than feeling uncomfortable when rejecting people, or shy when asking for a date, users can have a pressure-free conversation since the disclosed match-making system performs the “rejection” on behalf of users if any of the users select the according option.

2) Rather than sharing user contact or social media account with a person the user may not end up meeting, or meet but end up not continuing, and having them know their contact info or seeing them-on social media which could be uncomfortable and impossible to reverse (e.g phone number—unless the user changes his/her number), with the disclosed match-making system, users may not have to think about it, as the disclosed match-making system will disconnect users from other users who they do not wish to meet after interacting on the app of the disclosed match-making system. The disclosed match-making system will also make it less personal by giving them peace of mind that the person who they unmatched from does not have their contact or social media profile.

The app will be constructed in a way to keep it just about two people and safe. In an aspect, the match-making application is configured to provide video chat functionality.

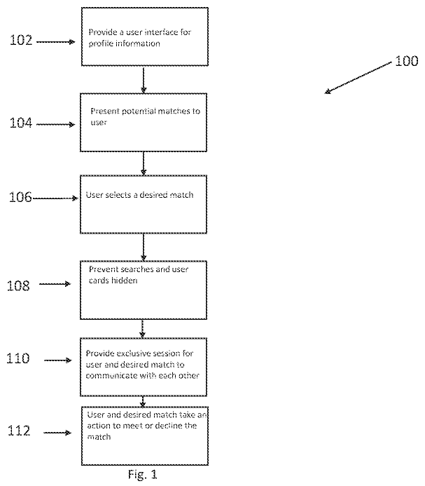

FIG. 1 is an example process flow 100 for acts taken in a method for matching interested parties in a dating environment using a match-making application, according to an aspect of the disclosure. Control begins at act 102.

At act 102, the disclosed match-making system provides a user interface for a user to enter profile information demographic information preferences, locational preferences and other pre-determined match criteria into the match-making application.

At act 104, the disclosed match-making system presents one or more potential matches to a user from the match-making application based on the user's demographic information preferences, locational preferences and other pre-determined match criteria.

At act 106, the disclosed match-making system allows the user to select a desired match from the one or more potential matches, such as by “swiping”—in an aspect, swiping right on a touchscreen means the user accepts the other user; left means they reject the other user.

Upon selecting the desired match by the user, at act 106, the disclosed match-making system then performs the following acts:

At act 108, the system allows connecting the user with the desired match within the match-making application to an exclusion of other potential matches in the match-making application, where a user profile card and a desired match profile card are hidden from other potential matches and a search for other potential matches is stopped for both the user and the desired match. No other searches or matches may be performed by the two users connected during this stage. The system stops all searches for the matched users and the matched user cards are hidden from other parties' view. The disclosed match-making system will prevent new messages into the two users' inboxes at this stage.

At act 110, the app becomes only for two users after the match occurs, and during which the user and the desired match communicate only with each other on the match-making application before the user and the desired match select to meet each other or end conversation

At act 112, the disclosed match-making system allows the user and desired match to take an action, such as selecting “I don't think it's a match.”

While the app becomes only for two users after the match occurs, as both users get to know each other, the disclosed match-making system does not un-match users unless one of the users chooses to do so later on by selecting “I don't think it's a match” option.

In an aspect of the disclosure, the disclosed match-making system disconnects these two users if any of the users select the option “I don't think it's a match” (un-matching them).

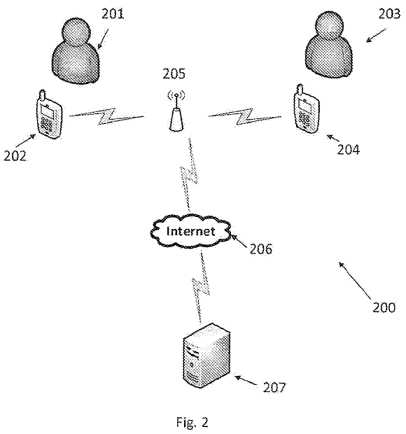

FIG. 2 illustrates an example communications network (200) employed by users (201, 203) that supports the disclosed match-making system. In an aspect of the disclosure, the users (201, 203) may be a user seeking to enroll in and use the match-making application.

The communications network (200) may include a first user equipment (UE) (202) and a second UE (204). There may be multiple UEs connected to the communications network (200) and the UEs may be smart phones, laptops, tablet devices, smart watches, desktop computers, or other equipment that can connect in a wired or wireless manner. The communications network (200) may include a wired or wireless access point (AP) (205). The AP (205) may be a terrestrial wireless network such as a cellular communications network, WiFi network or other wireless connectivity systems. The AP (205) may be a satellite that supports ground-based communications. Examples of a wired communications network includes Ethernet, fiber, cable or other wired communications connectivity systems.

In an aspect of the disclosed disclosure, the AP (205) may connect to the Internet (206), as understood by one of skill in the art. The Internet (206) may include various routers and hubs (not shown).

In an aspect of the disclosed disclosure, the Internet (206) may connect UEs (202, 204) to a server (207). The server (207) may contain processors, input units, memory, and output display units (not shown). The server (207) may support the functions of the disclosed system and method. The server (207) may be multiple servers and the method of the disclosed disclosure may be implemented across multiple servers, the UEs (202, 204) or other processing devices as needed. The server (207) may also include a cloud-based collection of one or more servers distributed in different locations and/or or making use of cloud-based applications to implement the disclosed disclosure.

In an aspect, the server (207) may be located in local proximity to the UEs (202, 204) such that the UEs (202, 204) do not access the Internet (206) to make use of the disclosed disclosure.

The sequence diagram in FIG. 1 may be encoded in a signal bearing medium, a computer readable medium such as a memory, programmed within a device such as one or more integrated circuits, or processed by a controller or a computer. If the methods are performed by software, the software may reside in a memory resident to or interfaced to the any type of non-volatile or volatile memory interfaced or resident to the memory incorporated in the components in the communications network (200). Such memory may include an ordered listing of executable instructions for implementing logical functions. A logical function may be implemented through digital circuitry, through source code, through analog circuitry, or through an analog source such through an analog electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various aspects of the disclosure have been described, it will be apparent to those of ordinary skill in the art that many more aspects and implementations are possible within the scope of the disclosure. Accordingly, the disclosure is not to be restricted except in light of the attached claims and their equivalents.

What is claimed is:

1. A computer-implemented method for matching interested parties in a dating environment using a match-making application, the method comprising:
providing a user interface for a user to enter profile information into the match-making application;
presenting one or more potential matches to a user from the match-making application based on a user's demographic information preferences, locational preferences and/or pre-determined match criteria;
allowing the user to select a desired match from the one or more potential matches; and
upon selecting the desired match by the user:
connecting the user with the desired match within the match-making application to an exclusion of connecting with other potential matches in the match-making application, where a user profile card and a desired match profile card are hidden from other potential matches and a search for other potential matches is stopped for both the user and the desired match;
providing a session for the user and the desired match to communicate with each other exclusively on the match-making application until the user and/or the desired match initiate a selection action; and
where the user and the potential match communicate exclusively with each other.

2. The method of claim 1, where the selection action comprises one of: deciding, by the user and desired match to continue conversation; or deciding, by at least one of the user and the desired match to end conversation.

3. The method of claim 1, where selecting the desired match by the user comprises swiping in a first direction, on a touchscreen display, to select the desired match and swiping, in a second direction, to not select the desired match.

4. An apparatus comprising:
at least one processor; and
at least one memory including computer program code for one or more programs,
the at least one memory and the computer program code configured to, with the at least one processor, cause the apparatus to perform at least the following:
providing a user interface for a user to enter profile information into the match-making application;
presenting one or more potential matches to a user from the match-making application based on a user's demographic information preferences, locational preferences and pre-determined match criteria;
allowing the user to select a desired match from the one or more potential matches; and
upon selecting the desired match by the user:
connecting the user with the desired match within the match-making application to an exclusion of connecting with other potential matches in the match-making application, where a user profile card and a desired match profile card are hidden from other potential matches and a search for other potential matches is stopped for both the user and the desired match, while the user and the potential match communicate exclusively with each other.

5. The apparatus of claim 4, where the selection action comprises one of: deciding, by the user and desired match to continue conversation; or deciding, by at least one of the user and the desired match to end conversation.

6. The apparatus of claim 4, where selecting the desired match by the user comprises swiping in a first direction, on a touchscreen display, to select the desired match and swiping, in a second direction, to not select the desired match.

7. A non-transitory computer-readable storage medium carrying one or more sequences of one or more instructions which, when executed by one or more processors, cause an apparatus to perform:
providing a user interface for a user to enter profile information into the match-making application;
presenting one or more potential matches to a user from the match-making application based on the user's demographic information preferences, locational preferences and pre-determined match criteria;
allowing the user to select a desired match from the one or more potential matches; and
upon selecting the desired match by the user:
connecting the user with the desired match within the match-making application to an exclusion of connecting with other potential matches in the match-making application, where a user profile card and a desired match profile card are hidden from other potential matches and a search for other potential matches is stopped for both the user and the desired match; and
where the user and the potential match communicate exclusively with each other.

8. The non-transitory computer-readable storage medium of claim 7, where the selection action comprises deciding by at least one of the user and the desired match to end conversation.

9. The non-transitory computer-readable storage medium of claim 7, where selecting the desired match by the user comprises swiping in a first direction, on a touchscreen display, to select the desired match and swiping, in a second direction, to not select the desired match.

10. The non-transitory computer-readable storage medium of claim 7, further comprising instructions to provide a graphical user interface on a touchscreen display.

11. The non-transitory computer-readable storage medium of claim 7, further comprising a region on the touchscreen display to select the desired match by the user or reject the desired match by the user.
